(19) United States
(12) Patent Application Publication
(10) Pub. No.: US 2014/0149202 A1
(43) Pub. Date: May 29, 2014

(54) METHOD AND SYSTEM FOR COMBINED TIME AND LOCATION BASED OFFERS

(71) Applicant: MASTERCARD INTERNATIONAL INCORPORATED, Purchase, NY (US)

(72) Inventor: Trevor OWEN, O'Fallon, MO (US)

(73) Assignee: MasterCard International Incorporated, Purchase, NY (US)

(21) Appl. No.: 13/686,606

(22) Filed: Nov. 27, 2012

(51) Int. Cl. G06Q 30/02

(52) U.S. Cl. CPC G06Q 30/0235
USPC 705/14.35

(57) ABSTRACT

A method for distributing a time- and location-based offer to a consumer includes: storing coupons and locations, each location including at least one geographic position; receiving a location from a device at an entry time; identifying a specific location where the included geographic position is in proximity to the location of the device; identifying at least one stored coupon corresponding to the specific location; calculating an elapsed time based on the amount of time passed since the entry time; and distributing, to a consumer and/or the device, the at least one stored coupon when a time threshold for the coupon is met or exceeded by the elapsed time, where the calculating and distributing are performed until the device has left the geographic position. Coupons may also be distributed based on aggregated time at a location or category of locations, or aggregated time of a group of consumers.

### FIELD

The present disclosure relates to the distribution of offers to a consumer, specifically the distribution of offers to a consumer based on both the consumer's location and length of time at the location.

### BACKGROUND

Many consumers, especially at the start of a new year or a new personal venture, make a resolution to improve their health and their body by regularly exercising and joining a new gym or health club. However, for many of these consumers, a lack of immediate results and gratification may lead to lessened motivation, which can sometimes result in the consumer giving up on their resolution entirely. Consumers, as well as their gym or health club, would benefit from an additional incentive to regularly working out, especially to one that may offer results quicker and/or more often.

In addition, third parties may also have a desire for consumers to spend more time at exercising. For example, health insurance providers often provide discounts or rewards to consumers when they achieve certain goals or perform certain actions, as they like to reward their consumers for becoming healthier. Consumers, in addition to improving their overall health, also get these rewards and discounts as an additional incentive. However, health insurance providers are often unable to see results from a consumer to incentivize in a shorter term, much like the consumer's desired results as well.

Thus, there is a need to incentivize time spent by a consumer at a particular location, such as their gym or health club. In addition, other institutions may benefit from incentivizing time spent at a particular location by a consumer, such as educational institutions, museums, art galleries, shopping malls, etc., which may provide a benefit to both the institution and the enrichment of the consumer. Merchants and retailers may also receive a benefit from consumers that spend more time at their location, as the consumer may be more inclined to purchase additional goods or services.

Accordingly, there is a need for a technical solution to provide offers that are both time- and location-based to a consumer.

### SUMMARY

The present disclosure provides a description of a systems and methods for the distribution of time- and location-based distribution of offers and a system and method for the distribution of a time- and location-based activity.

A method for distributing a time- and location-based offer to a consumer includes: storing, in a coupon database, a plurality of coupon data entries, wherein each coupon data entry includes data related to a coupon and includes at least a location identification and a time threshold; storing, in a location database, a plurality of location data entries, wherein each location data entry includes data related to a location and includes at least a location identifier and at least one geographic position; receiving, by a receiving device, a location notification from a mobile communication device, wherein the location notification includes at least an entry time and a geographic location; identifying, in the location database, a specific location data entry, wherein one of the at least one geographic position included in the specific location data entry is in proximity to the geographic location; identifying, in the coupon database, at least one coupon data entry, wherein the location identification of each of the at least one coupon data entry corresponds to the location identifier of the specific location data entry; calculating an elapsed time based on the amount of time passed since the entry time included in the location notification; and distributing, to a consumer associated with the mobile communication device, each coupon related to each of the at least one coupon data entry when the elapsed time meets or exceeds the included time threshold, wherein the calculating and distributing steps are performed until the receiving device receives an indication that the mobile communication device is not in proximity of the geographic location.

Another method for distributing a time- and location-based offer to a consumer includes: storing, in a coupon database, a plurality of coupon data entries, wherein each coupon data entry includes data related to a coupon and includes at least a location identification and a time threshold; storing, in a location database, a plurality of location data entries, wherein each location data entry includes data related to a location and includes at least a location identifier and at least one geographic position; receiving, by a receiving device, a location notification from a mobile communication device, wherein the location notification includes at least an entry time and a geographic location; receiving, by the receiving device, an exit notification from the mobile communication device, the exit notification including at least an exit time; calculating, by a processing device, an elapsed time based on the received entry time and exit time; identifying, in the location database, a specific location data entry, wherein one of the at least one geographic position included in the specific location data entry is in proximity to the geographic location; identifying, in the coupon database, at least one coupon data entry, wherein the location identification of each of the at least one coupon data entry corresponds to the location identifier of the specific location data entry and the calculated elapsed time meets or exceeds the time threshold; and distributing, to a consumer associated with the mobile communication device, each coupon related to each of the at least one coupon data entry.

A method for distributing time- and location-based activity includes: storing, in an entity database, a plurality of entity data entries, wherein each entity data entry includes data related to an entity and includes at least a time threshold and an activity identification; storing, in an activity database, a plurality of activity data entries, wherein each activity data entry includes data related to an activity and includes an activity identifier and at least one geographic position; storing, in a consumer database, a plurality of consumer data entries, wherein each consumer data entry includes data related to a consumer and includes at least a consumer identifier, an activity indicator, and an aggregated time; receiving, by a receiving device, an activity notification, wherein the activity notification includes at least a consumer identification, an elapsed time, and a geographic location; identifying, in the activity database, a specific activity data entry, wherein the geographic location corresponds to one of the at least one geographic positions included in the specific activity data entry; identifying, in the consumer database, a specific consumer data entry, wherein the consumer identification corresponds to the consumer identifier included in the specific consumer data entry and wherein the activity identifier of the specific activity data entry corresponds to the activity indicator included in the specific consumer data entry; updating the aggregated time in the specific consumer data entry based on the elapsed time included in the activity notification; identifying, in the entity database, a specific data entry, wherein the activity identifier of the specific activity data entry corresponds to the activity identification included in the specific entity data entry and the updated aggregated time meets or exceeds the time threshold included in the specific entity data entry; and transmitting, to the entity related to the specific entity data entry, at least the consumer identifier included in the specific consumer data entry.

A system for distributing a time- and location-based offer to a consumer includes a coupon database, a location database, a receiving device, a processing device, and a transmitting device. The coupon database is configured to store a plurality of coupon data entries, wherein each coupon data entry includes data related to a coupon and includes at least a location identification and a time threshold. The location database is configured to a plurality of location data entries, wherein each location data entry includes data related to a location and includes at least a location identifier and at least one geographic position. The receiving device is configured to receive a location notification from a mobile communication device, wherein the location notification includes at least an entry time and a geographic location. The processing device is configured to: identify, in the location database, a specific location data entry, wherein one of the at least one geographic position included in the specific location data entry is in proximity to the geographic location; identify, in the coupon database, at least one coupon data entry, wherein the location identification of each of the at least one coupon data entry corresponds to the location identifier of the specific location data entry; and calculate an elapsed time based on the amount of time passed since the entry time included in the location notification. The transmitting device is configured to distribute, to a consumer associated with the mobile communication device, each coupon related to each of the at least one coupon data entry when the elapsed time meets or exceeds the included time threshold. The processing device is further configured to perform the calculating and distributing steps until the receiving device receives an indication that the mobile communication device is not in proximity of the geographic location.

Another system for distributing a time- and location-based offer to a consumer includes a coupon database, a location database, a receiving device, a processing device, and a transmitting device. The coupon database is configured to store a plurality of coupon data entries, wherein each coupon data entry includes data related to a coupon and includes at least a location identification and a time threshold. The location database is configured to store a plurality of location data entries, wherein each location data entry includes data related to a location and includes at least a location identifier and at least one geographic position. The receiving device is configured to receive a location notification from a mobile communication device, wherein the location notification includes at least an entry time and a geographic location, and receive an exit notification from the mobile communication device, the exit notification including at least an exit time. The processing device is configured to calculate an elapsed time based on the received entry time and exit time; identify, in the location database, a specific location data entry, wherein one of the at least one geographic position included in the specific location data entry is in proximity to the geographic location; and identify, in the coupon database, at least one coupon data entry, wherein the location identification of each of the at least one coupon data entry corresponds to the location identifier of the specific location data entry and the calculated elapsed time meets or exceeds the time threshold. The transmitting device is configured to distribute to a consumer associated with the mobile communication device, each coupon related to each of the at least one coupon data entry.

A system for distributing time- and location-based activity includes an entity database, an activity database, a consumer database, a receiving device, a processing device, and a transmitting device. The entity database is configured to store a plurality of entity data entries, wherein each entity data entry includes data related to an entity and includes at least a time threshold and an activity identification. The activity database is configured to store a plurality of activity data entries, wherein each activity data entry includes data related to an activity and includes an activity identifier and at least one geographic position. The consumer database is configured to store a plurality of consumer data entries, wherein each consumer data entry includes data related to a consumer and includes at least a consumer identifier, an activity indicator, and an aggregated time. The receiving device is configured to receive an activity notification, wherein the activity notification includes at least a consumer identification, an elapsed time, and a geographic location. The processing device is configured to identify, in the activity database, a specific activity data entry, wherein the geographic location corresponds to one of the at least one geographic positions included in the specific activity data entry; identify, in the consumer database, a specific consumer data entry, wherein the consumer identification corresponds to the consumer identifier included in the specific consumer data entry and wherein the activity identifier of the specific activity data entry corresponds to the activity indicator included in the specific consumer data entry; update the aggregated time in the specific consumer data entry based on the elapsed time included in the activity notification; and identify, in the entity database, a specific data entry, wherein the activity identifier of the specific activity data entry corresponds to the activity identification included in the specific entity data entry and the updated aggregated time meets or exceeds the time threshold included in the specific entity data entry. The transmitting device is configured to transmit, to the entity related to the specific entity data entry, at least the consumer identifier included in the specific consumer data entry.

### BRIEF DESCRIPTION OF THE DRAWING FIGURES

Exemplary embodiments are best understood from the following detailed description when read in conjunction with the accompanying drawings. Included in the drawings are the following figures:

FIG. 1 is a block diagram illustrating a system for the distribution of time- and location-based offers and activities.

FIG. 2 is a block diagram illustrating a processing server for use in the system of FIG. 1 in accordance with exemplary embodiments.

FIG. 3 is a block diagram illustrating the correlation of data stored in the databases of the processing server of FIG. 2 in accordance with exemplary embodiments.

FIG. 4 is a block diagram illustrating a system for the distribution of time- and location-based offers using aggregation among a plurality of consumers in accordance with exemplary embodiments.

FIG. 5 is a block diagram illustrating the correlation of data stored in the databases of the processing server of the system of FIG. 4 in accordance with exemplary embodiments.

FIGS. 6A-6G are illustrations of a graphical user interface of the consumer device of FIG. 1 in accordance with exemplary embodiments.

FIG. 7 is a flowchart illustrating a method for distributing time- and location-based offers to a consumer in accordance with exemplary embodiments.

FIG. 8 is a block diagram illustrating system architecture of a computer system in accordance with exemplary embodiments.

FIGS. 9 and 10 are flow charts illustrating exemplary methods for distributing time- and location-based offers in accordance with exemplary embodiments.

FIG. 11 is a flow chart illustrating an exemplary method for distributing time- and location-based activity in accordance with exemplary embodiments. Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Distributing Time- and Location-Based Offers and Activities

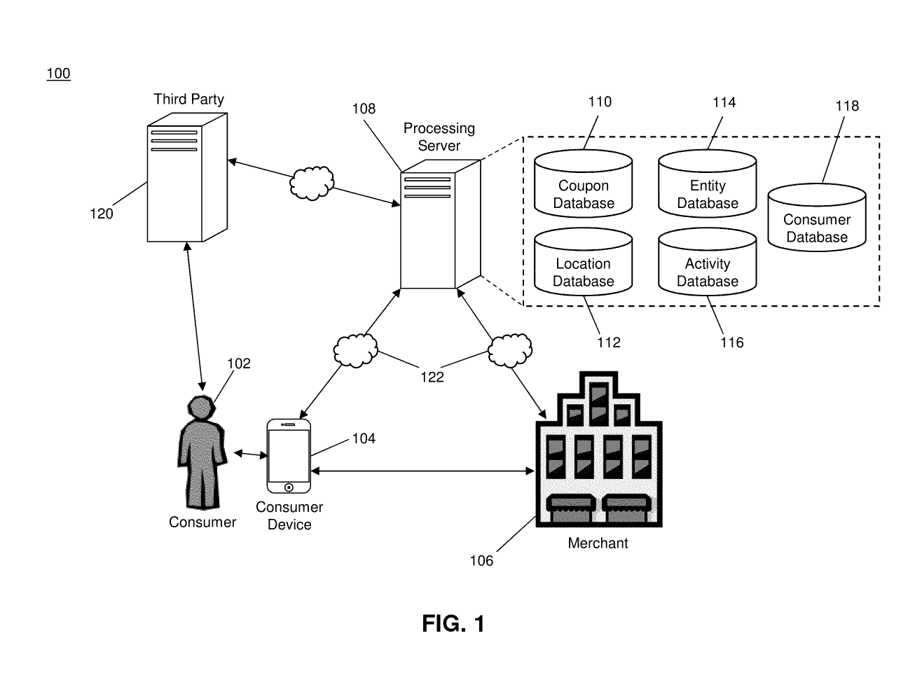

FIG. 1 is a block diagram illustrating a system 100 for distributing time- and location-based offers and activities.

The system 100 may include a consumer 102. The consumer 102 may possess a consumer device 104. The consumer device 104 may be any type of mobile communication device suitable for performing the functions as discussed herein, such as a cellular phone, a smart phone, a tablet computer, etc. The consumer 102, in possession of the consumer device 104, may visit a merchant 106.

While at the merchant 106, the consumer device 104 may identify its geographic location, which may then be transmitted to a processing server 108 via a network 122. Methods for identifying the geographic location of the consumer device 104 will be apparent to persons having skill in the relevant art and may include identifying location via the Global Positioning System (GPS), by connecting to a localized wireless network, by scanning a machine-readable code displayed at the merchant 106, by scanning a machine-readable code encoded with the geographic location, etc. In an exemplary embodiment, the geographic location may be represented by latitude and longitude.

The network 122 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art.

The processing server 108 may receive the location of the consumer device 104. The processing server 108 may identify a location identifier for the geographic location, which may be a unique value corresponding to at least one geographic location, in a location database 112, as discussed in more detail below. The processing server 108 may identify coupons or offers in a coupon database 110 as associated with the identified location identifier. Each of the identified coupons may include an elapsed time, which may represent an amount of time the consumer device 104 must remain at or near (e.g., within a predefined distance) the geographic location.

Once the consumer device 104 has been at or near the geographic location for at least the elapsed time, then the processing server 108 may distribute the corresponding offer from the coupon database 110 to the consumer 102. Methods for identifying the elapsed time for which the consumer 102 has been at the geographic location will be apparent to persons having skill in the relevant art. For example, the consumer device 104 may transmit its geographic location at regular intervals to the processing server 108. In another example, the consumer device 104 may transmit its geographic location and the time at which the consumer device 104 arrived at the geographic location, and the processing server 108 may wait until the elapsed time for corresponding offers and request the current geographic location of the consumer device 104 to determine if they are located in the same area.

The identified coupon or offer may be distributed to the consumer 102 and the consumer device 104 by e-mail, traditional mail, short message service (SMS) message, multimedia message service (MMS) message, via an application program on the consumer device 104, or may be associated with a financial account of the consumer 102 to be automatically applied during a subsequent financial transaction. Additional methods suitable for the distribution of coupons to the consumer 102 or the consumer device 104 will be apparent to persons having skill in the relevant art.

The processing server 108 may be further configured to track an aggregated time for which the consumer device 104 has been at the merchant 106 across multiple visits, an aggregated time for which the consumer device 104 and associated consumer devices have been at the merchant 106, and an aggregated time for which the consumer device 104 has been at a plurality of merchants of a specific merchant category, as discussed in more detail below.

In some embodiments, a third party 120, such as a health insurance company, may request activity information for the consumer 102, such as the amount of time that the consumer 102 has spent at a specific merchant, such as gyms and health clubs. The processing server 108 may store activity information for the consumer 102 in a consumer database 118, as discussed in more detail below. The processing server 108 may identify information related to the aggregate time of the consumer 102 located at merchants in the corresponding merchant category, and transmit the information to the third party 120 to fulfill the request.

### Processing Server

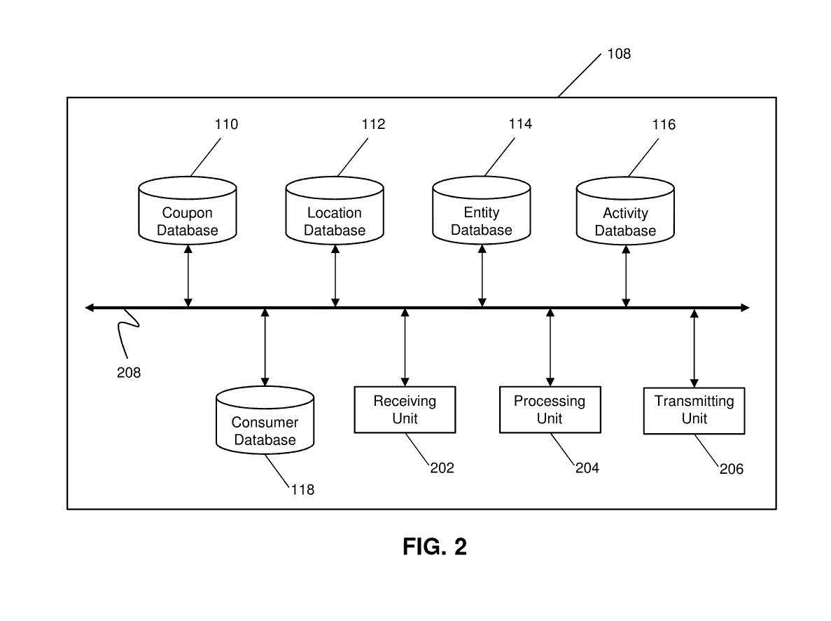

FIG. 2 illustrates an embodiment of the processing server 102 for use in the system 100 for distributing time- and location-based offers and activities.

The processing server 102 may include the coupon database 110, the location database 112, an entity database 114, an activity database 116, and the consumer database 118 (the “databases”). Data stored in the databases may be stored on any type of suitable computer readable media, such as optical storage (e.g., a compact disc, digital versatile disc, Blu-ray disc, etc.) or magnetic tape storage (e.g., a hard disk drive). The databases may be configured in any type of suitable database configuration, such as a relational database, a structured query language (SQL) database, a distributed database, an object database, etc. Suitable configurations and database storage types will be apparent to persons having skill in the relevant art. The databases may each be a single database, or may comprise multiple databases which may be interfaced together (e.g., physically or via a network, such as the network 122).

The processing server 102 may further include a receiving unit 202, a processing unit 204, and a transmitting unit 206. Each of the components may be configured to communicate via a bus 208. Suitable types and configurations of the bus 208 will be apparent to persons having skill in the relevant art.

The coupon database 110 may be configured to store a plurality of coupon, deal, or offer data entries related to respective coupons, deals, or offers for distribution to consumers (e.g., the consumer 102). Each coupon data entry in the coupon database 110 may include at least a location identifier and a time threshold. Each coupon data entry may also include additional information as will be apparent to persons having skill in the relevant art, such as a coupon name, coupon description, transaction modifier, quantity, expiration date, start date, minimum transaction amount, terms and conditions, limitations on redemption, etc. The location identifier may be a value corresponding to a unique geographic location as stored in the location database 112 and discussed in more detail below. The time threshold may be a specific elapsed time during which the consumer device 104 must remain at the corresponding geographic location. Once the elapsed time for the consumer device 104 exceeds the time threshold, then the processing server 108 may distribute the related coupon to the consumer 102 and/or the consumer device 104 via the transmitting unit 206.

The location database 112 may be configured to store a plurality of location data entries. Each location data entry may be related to a location (e.g., a location where the consumer 102 may earn offers, such as the merchant 106) and may include at least a location identifier and at least one geographic location. In some embodiments, each location data entry may include a plurality of geographic locations, which may serve as points outlining a geographic area for which the location identifier applies (e.g., such as coordinates outlining the physical location of the merchant 106). In other embodiments, each location data entry may further include a distance such that if a consumer device 104 may be considered at the corresponding geographic location if within the included distance. In some instances, each location data entry may include a plurality of geographic locations or groups of geographic locations, such as corresponding to multiple store locations for a particular merchant or retailer.

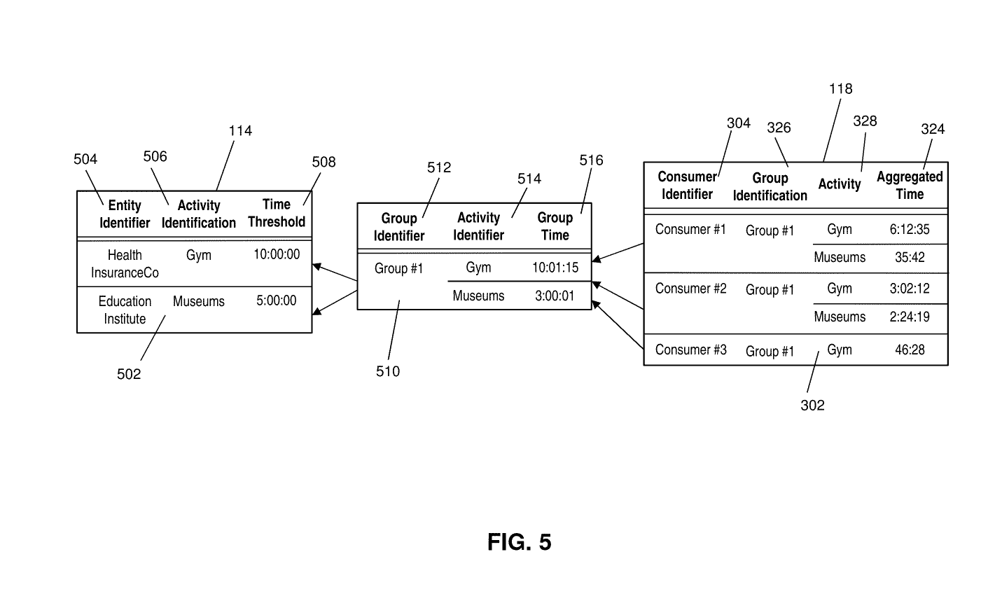

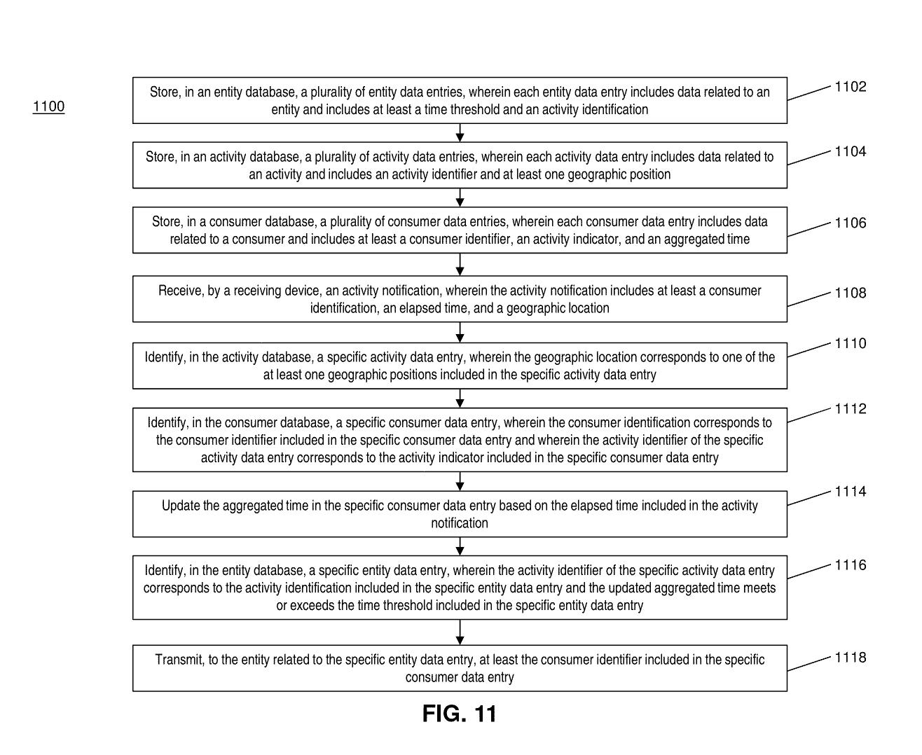

The entity database 114 may be configured to store a plurality of entity data entries related to entities, such as the third party 120. Each entity data entry may include at least an entity identifier, which may be a unique value associated with a specific entity (e.g., the third party 120), an activity identifier, and a time threshold. The activity identifier may be a unique value corresponding to a specific activity data entry stored in the activity database 116, discussed in more detail below. The time threshold may be an aggregated time. Once the processing server 108 identifies that a consumer 102 or group of consumers, discussed in more detail below, has been located at merchants corresponding to the activity based on the included activity identifier for an aggregated time that exceeds the time threshold, then the processing server 108 may notify the corresponding entity of the exceeding of the time threshold by the corresponding consumer 102 or group of consumers. The distribution of consumer information to an entity based on time- and location-based activity is discussed in more detail below and illustrated in FIGS. 5 and 11. In some embodiments, entries in the entity database 114 may include the same entity identifier or activity identifier without any entry including the same combination of entity identifier and activity identifier, such that an entity may be notified of consumer activity for a plurality of different activities.

The activity database 116 may be configured to store a plurality of activity data entries. Each activity may be related to an activity and may include an activity identifier and at least one location identifier. The activity identifier may be a unique value corresponding to a specific activity (e.g., a merchant category), such as gyms and health clubs, museums, educational institutions, theme parks, stadiums and arenas, sporting goods stores, retail stores, etc. The at least one location identifier for each activity data entry may correspond to at least one location data entry in the location database 112 where the corresponding geographic location(s) are associated with the activity. For example, for an activity data entry in the activity database 116 corresponding to gyms and health clubs, the entry in the activity database 116 may include the location identifier corresponding to each of three different gyms and two health clubs.

The consumer database 118 may be configured to store a plurality of consumer data entries. Each consumer data entry may be related to a consumer and include a consumer identifier, which may be a unique value corresponding to the related consumer (e.g., the consumer 102), such as a username, e-mail address, phone number, financial account number, media access control (MAC) address for the consumer device 104, or any other value suitable for uniquely identifying the consumer 102 as will be apparent to persons having skill in the relevant art. Each consumer data entry may also include additional information as discussed in more detail below depending on the application. For example, in one embodiment, each consumer data entry may include at least one geographic locations and a corresponding elapsed time, for the distribution of coupons to the consumer 102. In a further embodiment, the consumer data entry may further include an aggregated time for each geographic location. In another embodiment, the each consumer data entry may include at least one activity identifier and a corresponding aggregated time. In yet another embodiment, each consumer data entry may also include a group identifier, corresponding to a group of consumers for a group aggregated time as discussed in more detail below. In some embodiments, each consumer data entry may include a method of distribution and distribution details for the distribution of offers to the consumer 102 and/or the consumer device 104.

The receiving unit 202 of the processing server 108 may be configured to receive consumer information, such as registration information from a consumer 102 for enrollment in an offer distribution service for the distribution of coupons to the consumer 102 based on elapsed or aggregated time at a location or activity, which may then be stored by the processing unit 204 in the consumer database 118. The receiving unit 202 may be further configured to receive location information from the consumer device 104 for tracking of the elapsed and/or aggregated time of the consumer 102 at a geographic location or activity. The processing unit 204 may be configured to process the received location information to identify a corresponding location data entry in the location database 112, and in some instances may be further configured to identify a corresponding activity data entry in the activity database 116.

The transmitting unit 206 may be configured to transmit coupons or offers related to coupon data entries stored in the coupon database 110 to the consumer 102 (e.g., via the consumer device 104). Methods of transmitting coupons or offers to a consumer or consumer device will be apparent to persons having skill in the relevant art and may include e-mail, SMS message, and MMS message. The transmitting unit 206 may also be configured to transmit consumer or group information from the consumer database 118 and/or the activity database 116 to the third party 120, such as consumer and/or group identifiers and aggregated or elapsed time for a requested activity or location.

### Identification of Time- and Location-Based Offers for Distribution

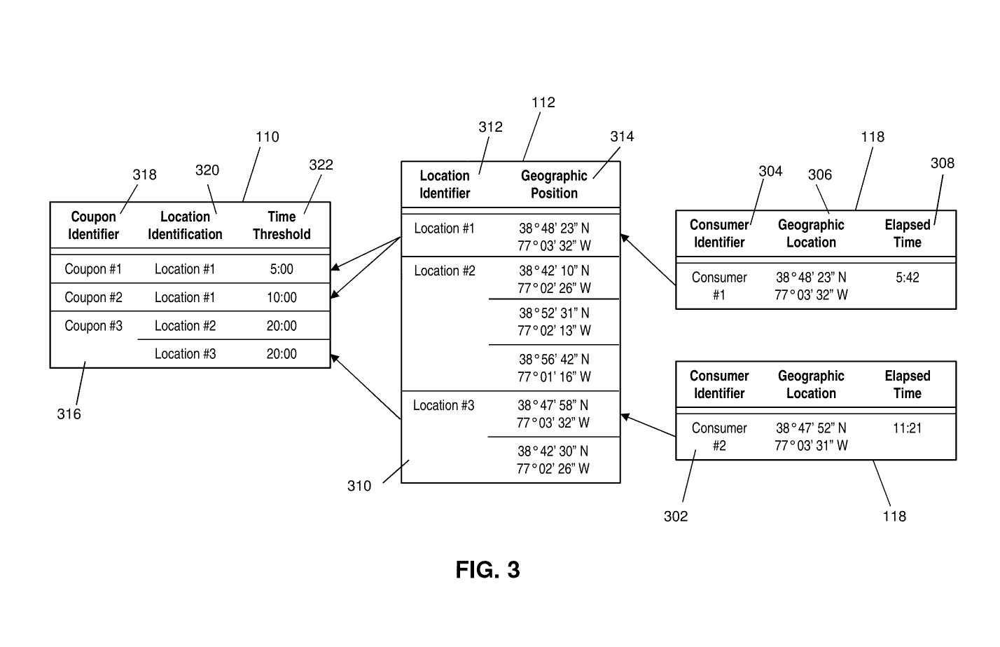

FIG. 3 is an illustration of an example data set included in the databases of the processing server 108 for the identification of time- and location-based offers for distribution to consumers.

As illustrated in FIG. 3, the consumer database 118 may store a plurality of consumer data entries 302. Each consumer data entry 302 may include a consumer identifier 304 corresponding to the entry's related consumer (e.g., the consumer 102), a geographic location 306, and an elapsed time 308. As discussed above, methods for identifying the elapsed time 308 of the consumer 102 at the geographic location 306 will be apparent to persons having skill in the relevant art. The location database 112 may store a plurality of location data entries 310. Each location data entry 310 may include a location identifier 312 corresponding to the related location (e.g., the merchant 106) and at least one geographic position 314.

The processing unit 204 may be configured to identify, in the location database 112, the corresponding location data entry 310 of each consumer 302 based on the corresponding geographic location 306. As illustrated in FIG. 3, consumer #1 may be identified as being located at location #1, and consumer #2 may be identified as being located at location #3 based on the corresponding geographic locations 306 and geographic positions 314.

The coupon database 110 may be store a plurality of coupon data entries 316. Each coupon data entry 316 may include a coupon identifier 318, a location identification 320, and a time threshold 322. The processing unit 204 may be configured to identify coupon data entries 316 in the coupon database 110 for possible distribution of related coupons to the consumers related to consumer data entries 302 based on the corresponding location identifications.

As illustrated in FIG. 3, the processing unit 204 may identify coupon #1 and coupon #2 as being eligible for distribution to consumer #1 due to the consumer #1 being located at location #1, for which both coupons apply. The processing unit 204 may identify the time threshold 322 for each of the two coupon data entries 316 and the elapsed time 308 for consumer #1 to determine if either of the eligible related coupons are to be distributed to the consumer 304. As illustrated in FIG. 3, the time threshold 322 for coupon #1 is met by consumer #1, but not the time threshold 322 for coupon #2. Accordingly, the transmitting unit 206 may transmit coupon #1 to consumer #1, but not coupon #2. In some embodiments, the consumer database 118 may store distribution information for each consumer data entry 302, such as a method of distribution by which coupon #1 may be transmitted to consumer #1.

In some instances, the transmitting unit 206 may transmit a notification to consumer #1 indicating an amount of time consumer #1 must remain at the geographic location 306 in order to receive coupon #2, which is just over 4 minutes in the illustrated example. Similarly, the processing unit 204 may identify consumer #2 as being eligible for coupon #3 based on the geographic location 118, but not able to receive the coupon yet due to the elapsed time 308 not meeting the time threshold 322 for coupon #3.

### Distribution of Time- and Location-Based Offers and Activities Using Aggregated Time

In some embodiments, coupon data entries 316 may include a time threshold 322 that may be based on the aggregated time a consumer is at a location over a period of visits instead of an elapsed time 308 the consumer is at the location in one instance. In a further embodiment, the aggregated time may be based on a specific time period (e.g., from one set date to another set date), or may be a recurring time period (e.g., aggregated time every month).

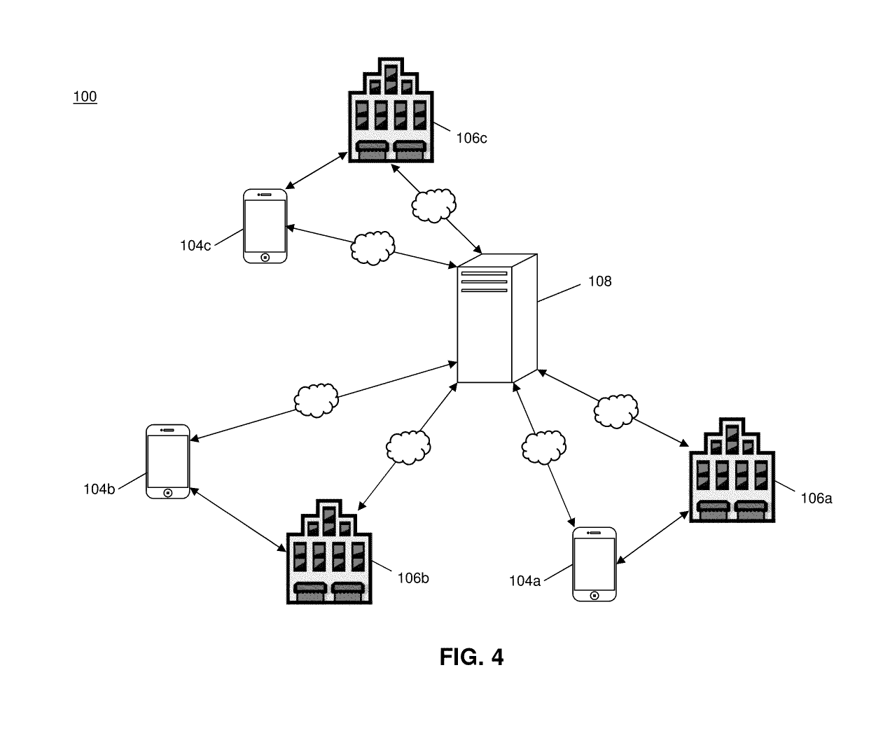

As discussed above, in some instances, aggregated time may be based on the time spent by a consumer at a plurality of locations corresponding to a specific activity. For example, multiple merchants, such as each of merchant 106a, 106b, and 106c illustrated in FIG. 4 may be included in a single activity data entry stored in the activity database 116 (e.g., based on the location identifiers 312 for the location data entries 310 corresponding to each of the merchants).

In some embodiments, consumers 102 may be able to join groups with other consumers to earn group-based coupons or offers. For example, a family of consumers may join a group, and the time that each family member spends at a location may be aggregated together as a single aggregated time for each the family may be eligible for coupons.

FIG. 4 illustrates the system 100 where consumers using consumer devices 104a, 104b, and 104c may each join together and form a group. Each of the consumer devices 104a, 104b, and 104c may be present at merchants 106a, 106b, and 106c, respectively, which may each be included in a specific activity data entry in the activity database 116. The elapsed time of each consumer device 104 at each merchant 106 may be received and stored as discussed above and illustrated in FIG. 3. The processing unit 204 may further store an aggregated time in the consumer data entry 302 for each consumer and/or for the group of consumers, which may be then compared to the time threshold 322 for coupon data entries 316 that are indicated to use aggregated time for the distribution of the related coupons to the group. In some instances, the aggregated activity time for the group of consumers, or for an individual consumer, may be transmitted to a third party (e.g., the third party 120), such as a health insurance company that may offer a reward to a family that has collectively spent a certain amount of time at a gym or health club.

FIG. 5 is an illustration of an example data set for data in the databases of the processing server 108 for the identification of group time- and location-based activity data for distribution to a third party.

The consumer database 118 may store the plurality of consumer data entries 302. Each consumer data entry 302 may include the consumer identifier 304, and may also include a group identification 326, an activity 328, and an aggregated time 324. The group identification 326 may be a unique value assigned to a group for which the related consumer 102 is included. In some embodiments, a consumer 102 may be included in a plurality of groups. The activity 328 may be a unique identifier corresponding to an activity data entry stored in the activity database 116. The aggregated time 324 may be an aggregation of elapsed times 308 for the related consumer 102 at locations corresponding to the activity. As illustrated in FIG. 5, each consumer data entry 302 may include a plurality of aggregated times 324 corresponding to multiple activities.

The processing unit 204 may identify information for a group 510, including the aggregated times 324 for each consumer data entry 302 located in the same group based on the group identification 326. As illustrated in FIG. 5, the information identified for the group 510 may include a group identifier 512, an activity identifier 514, and a group time 516. The group identifier 512 may correspond to the group identification 326 for consumer data entries 302 in the group 510. The activity identifier may correspond to the activity data entry in an activity database 116, and the group time 516 may be an aggregation of the aggregated times 324 for the corresponding activity for each consumer data entry 302 in the group 510.

As illustrated in FIG. 5, the processing unit 204 may identify the consumer #1, consumer #2, and consumer #3 each as being included in group #1. The processing unit 204 may calculate a group time 516 for each activity for which the group members have time, which is the Gym and Museums in the illustrated example. The group time 516 is calculated by the processing unit 204 in the example to be 10:01:15 for the Gym activity and 3:00:01 for the Museums activity.

The entity database 114 may store a plurality of entity data entries 502. Each entity data entry 502 may include an entity identifier 504, an activity identification 506, and a time threshold 508. The entity identifier 504 may be a unique value used to identify a related entity (e.g., the third party 120). As discussed above, each entity data entry 502 may be such that there may be multiple entries 502 including the same entity identifier 504 or activity identification 506, but not both, to allow for entities to include time thresholds 508 for multiple activities.

The processing unit 204 may identify if the group time 516 for a specific activity exceeds that of the time threshold 508 for the corresponding activity based on a comparison of activity identifiers 514 to activity identifications 114. If the time threshold 508 is exceeded by the group time, then the transmitting unit 206 may transmit corresponding information (e.g., identifying the group 510 or the consumers 302 in the group 510) to the entity corresponding to the entity identifier 504. As illustrated in FIG. 5, the processing unit 204 may identify that the group time 516 for Museums does not exceed the time threshold 508 for Museums set by the Education Institute, and thus take no action. The processing unit 204 may also identify that the group time 516 for the Gym activity exceeds the time threshold 508 for the activity set by Health InsuranceCo. The transmitting unit 206 may then transmit necessary group or consumer information to Health InsuranceCo, which Health InsuranceCo could use to provide rewards to members of group #1 due to their time spent exercising, for example.

It will be apparent to persons having skill in the relevant art that coupons may be distributed to groups 510 based on the same data as illustrated in FIG. 5, where the coupon database 110 may replace the entity database 114, and where the location identification 320 for each coupon data entry 316 is replaced by an activity identification 114, or where the activity identifier 514 and activity 328 for the group 510 and consumer 302, respectively, is replaced by location identifiers 312 and geographic locations 306, respectively. It should be apparent to persons having skill in the relevant art that the data illustrated in FIGS. 3 and 5 are used for illustrated purposes only and are not limitations.

In some embodiments, a consumer may also earn points based on elapsed time spent at a location. The earned points may be aggregated similar to the aggregation of elapsed time. In some instances, points may be separate for locations or activity, whereas in other instances, a consumer may have a single amount of points based on overall time spent at all eligible locations. The consumer may redeem the points for coupons and offers using methods that will be apparent to persons having skill in the relevant art.

### Graphical User Interface

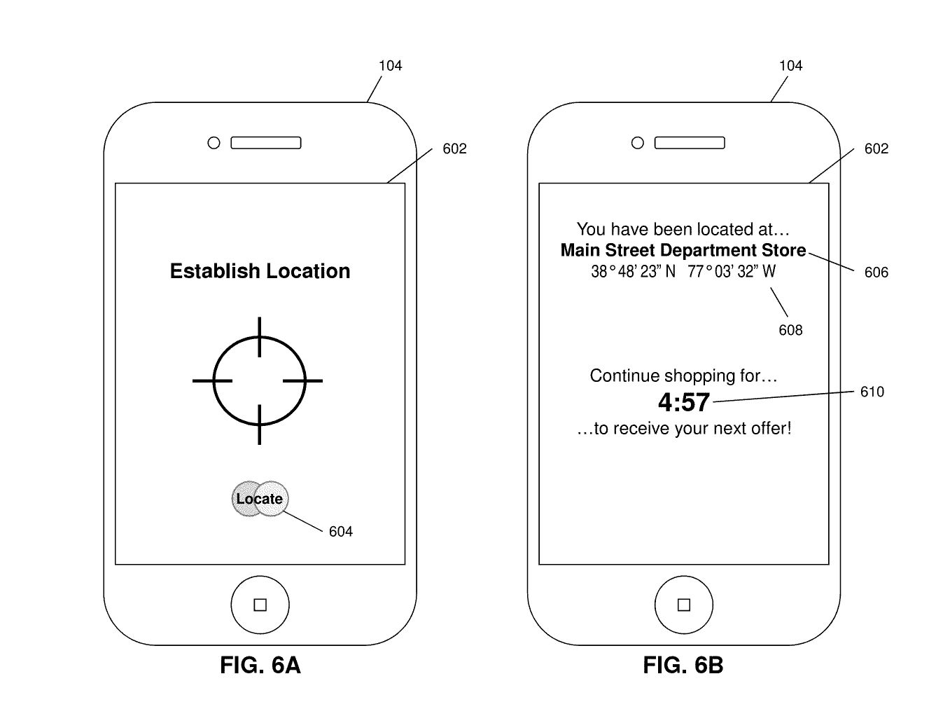

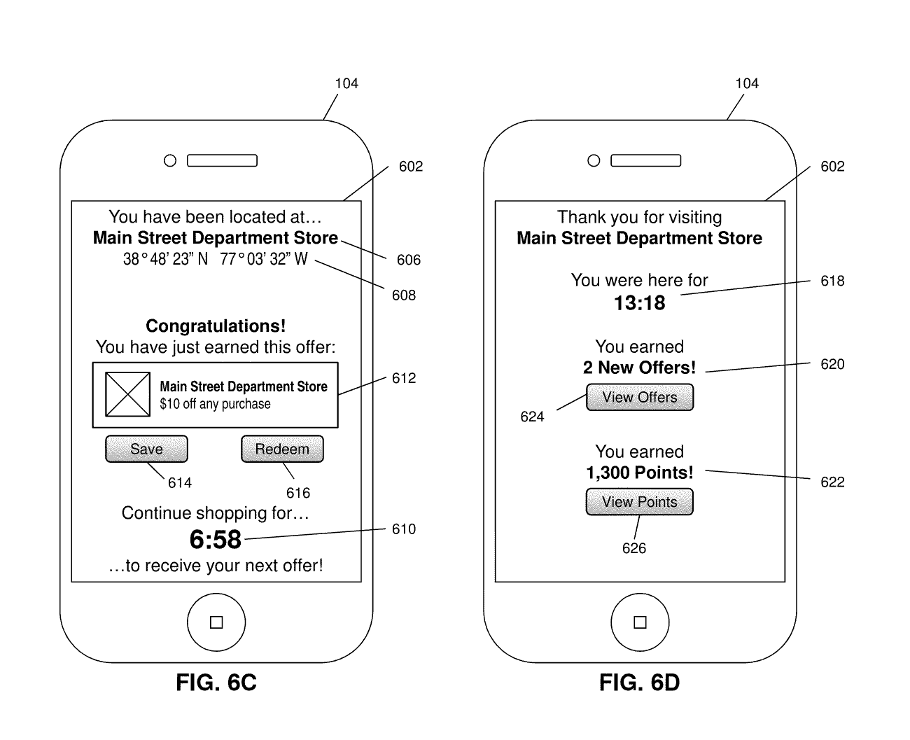

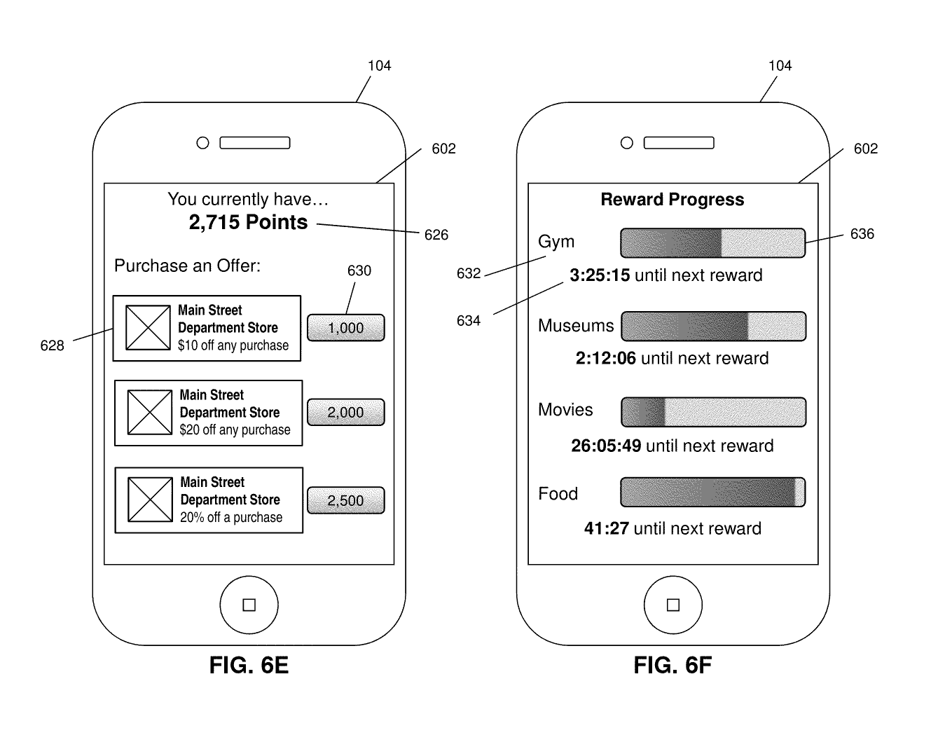

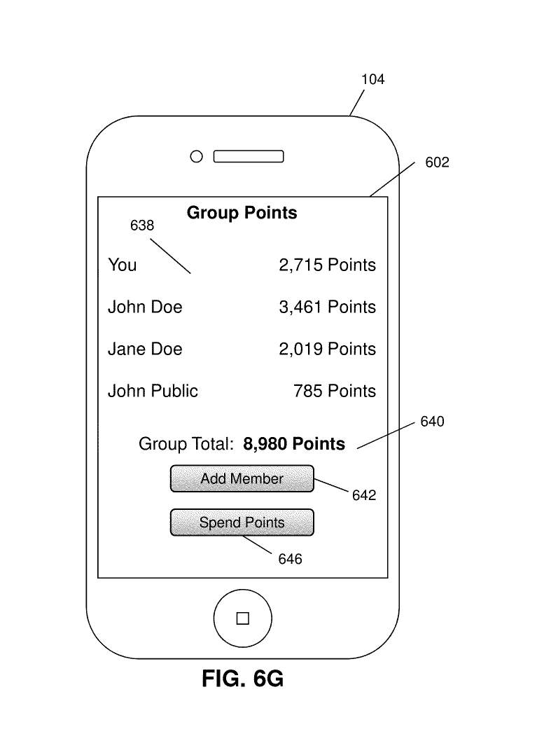

FIGS. 6A-6G are illustrations of an exemplary graphical user interface for display on the consumer device 104 for the transmission of time and location data to the processing server 108 and receipt of time- and location-based offers.

As illustrated in FIG. 6A, a display 602 of the consumer device 104 may display an indication that it is ready to establish the location of the consumer device 104 for transmission to the processing server 108. The display may include a locate button 604. When the user (e.g., the consumer 102) indicates with the locate button 604, the consumer device 104 may identify its geographic location and transmit it to the processing server 108 using methods that will be apparent to persons having skill in the relevant art.

Once the location of the consumer device 104 has been identified, then the display 602 may display the identified geographic location 608 to the consumer 102 as illustrated in FIG. 6B. The display may also include a name for the location 606 as identified by the processing server 108, which may be, for example, the name of the merchant 106 where the consumer 102 is located. The processing server 108 may identify any coupons for which the consumer 102 may be eligible at the identified location 608, and calculate a remaining time 610. The remaining time 610 may indicate the amount of time for which the consumer 102 must remain at the identified location 608 to exceed the next time threshold 322 to obtain a reward.

Once the elapsed time 308 stored in the consumer data entry related to the consumer 102 has exceeded a time threshold 322 for a coupon, then the display 602 may display information as illustrated in FIG. 6C to indicate to the consumer 102 that they have earned a reward. The display 602 may include the location 606 and the identified geographic location 608, and may also include the rewarded coupon 612. The rewarded coupon 612 may include any relevant information as will be apparent to persons having skill in the relevant art, such as a transaction modifier (e.g., $10 off a purchase). The display 602 may also include an updated remaining time 610 corresponding to the time until the next reward.

The display 602 may also include a save button 614. The save button 614, when interacted with by the consumer 102, may allow the consumer 102 to save the coupon 612 for future use, such as by having the coupon e-mailed or saved within an application program on the consumer device 104. The display may also include a redeem button 616. The redeem button 616 may be configured to process the coupon 612 for redemption. Methods for redemption of an electronic coupon will be apparent to persons having skill in the relevant art, and may include displaying a machine-readable code on the display 602 to be scanned at a point-of-sale, associating the coupon 612 with a financial account of the consumer 102 for automatic redemption during a financial transaction etc.

If the consumer device 104 and/or the processing server 108 identify that the consumer device 104 has left the geographic location 608, then the consumer device 104 may include the display 602 as illustrated in FIG. 6D. The display 602 may include a total elapsed time 618, which may represent the full elapsed time that the consumer 102 spent at the location 606. The display 602 may also indicate the number of offers 620 that the consumer 102 earned at the location 606. The display may include a view offers button 624, which may enable the consumer 102 to view a listing of the offers that were awarded during the visit. In embodiments where a consumer 102 may receive points for spending time at eligible locations, the display 602 may also include an earned point total 622 representing the number of points earned based on the time, and a view points button 626.

The view points button 626, when interacted with by the consumer 102, may cause the consumer device 104 to show a display 602 as illustrated in FIG. 6E. The display 602 may include a point total 626, which may represent all of the points earned by the consumer 102 that have not yet been redeemed. The display 602 may also include a plurality of coupons 628, for which points may be redeemed. Each coupon 628 may include a redeem button 630, which may indicate a point cost for the corresponding coupon. The consumer 102 may interact with the redeem button 630 to redeem points for the coupon 628, which may be processed using methods that will be apparent to persons having skill in the relevant art.

FIG. 6F is an illustration of a reward progress screen, which may provide the consumer 102 with a look at their current progress for activities and/or coupons based on aggregated time. The display 602 may include a plurality of activities or coupons 632. For each activity or coupon 632 the display 602 may also include a remaining time 634. The remaining time 634 may be a calculation of the time between the consumer's aggregated time 324 and the time threshold 508 for the corresponding activity or coupon 632. The display 602 may also include a progress bar 636, which may provide a graphical indication of the remaining time 634 compared to the overall time threshold 508 for the corresponding activity or coupon 632. It will be apparent to persons having skill in the relevant art that the display 602 of FIG. 6F may be suitable for the display of aggregated time coupons and activities for the consumer 102, or for a group of consumers 510 for which the consumer may be a member.

FIG. 6G is an illustration of a group point display. The display 602 may include a listing of group members 638, which may list each consumer of a group 510 and the number of points earned by each consumer. The display 602 may also include a group point total 640. The display 602 may further include an add member button 642 and a spend points button 646. The add member button 642 may be used to add another consumer to the group 510, and may be configured to be displayed only to eligible members. The spend points button 646 may be used to allow the consumer 102 to spend the group points, such as was illustrated for individual points in FIG. 6E. In some embodiments, the consumers may each vote on eligible offers to determine how the group points may be spent.

### Method for Distributing Time- and Location-Based Offers

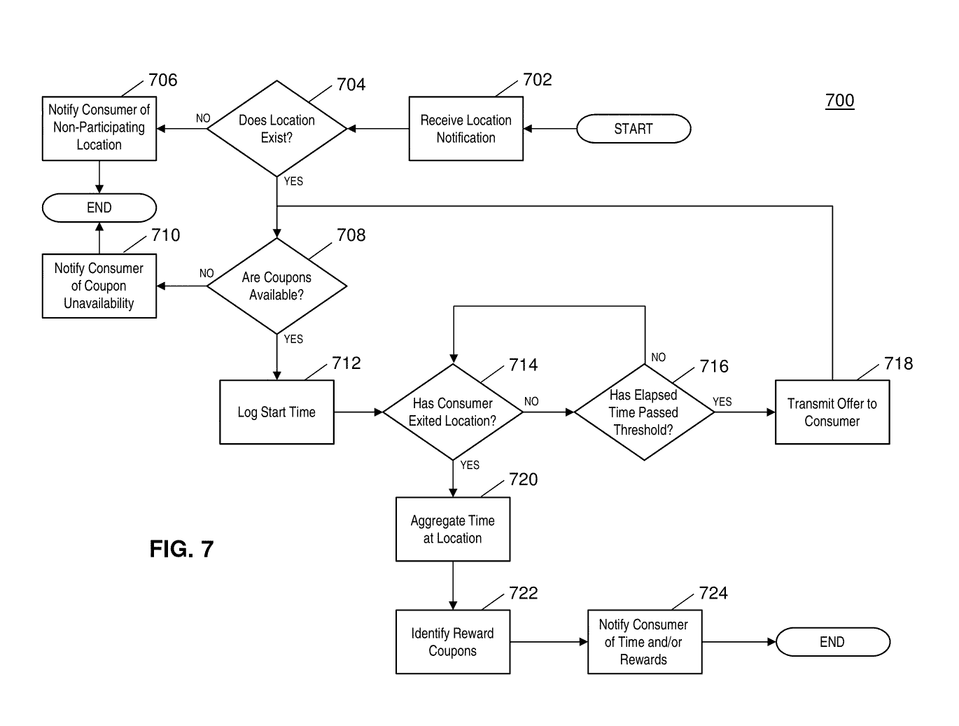

FIG. 7 illustrates a method 700 for the distribution of time- and location-based offers from the processing server 108 to the consumer 102 and/or the consumer device 104.

In step 702, the processing server 108 may (e.g., via the receiving unit 202) receive a location notification. The location notification may include at least an entry time and a geographic location 306 of the consumer device 104. In step 704, the processing unit 204 may determine if there exists in the location database 112 a corresponding geographic position 314, indicating the location as a participating location. If no such location data entry 310 in the location database 112 exists, then, in step 706, the transmitting unit 206 may transmit a notification to the consumer 102 and/or the consumer device 104 indicating that the location is not a participating location.

If a location data entry 310 exists in the location database 112 corresponding to the geographic location 306 of the consumer device 104, then, in step 708, the processing unit 204 may determine if there are coupons currently available. The processing unit 204 may identify coupon data entries 316 in the coupon database 110 that correspond to the location data entry 310 based on the included location identification. If there are no coupon data entries 316 identified, or any identified coupon data entries 316 may not have related coupons be distributed and/or redeemed (e.g., due to limited quantity, passed expiration date, etc.), then, in step 710, the transmitting unit 206 may transmit a notification to the consumer 102 and/or the consumer device 104 indicating the unavailability of coupons for that location.

If at least one coupon data entry 316 is identified, then, in step 712, the processing unit 204 may log (e.g., in the consumer database 118) the start time received in the location notification. In step 714, the processing unit 204 will identify if the consumer 102 has exited the related location using methods that will be apparent to persons having skill in the relevant art. If the consumer 102 (e.g., the consumer device 104) is still at the location, then, in step 716, the processing unit 204 will determine if the time elapsed since the start time has passed the time threshold 322 for the identified at least one coupon data entry 316.

If the elapsed time does not exceed a time threshold 322, then the method 700 may return to step 714 to determine the consumer's location. If the elapsed time does exceed the time threshold 322, then, in step 718, the transmitting unit 206 may transmit the corresponding coupon to the consumer 102. After the coupon is transmitted, the method 700 may return to step 708 to determine if there are additional coupons available.

If, in step 714, the processing unit 204 has identified that the consumer 102 (e.g., the consumer device 104) has exited the location, then, in step 720, the processing unit 204 may aggregate the consumer's time for that location and identify a corresponding aggregated time 324. In step 722, the processing unit 204 may identify any coupons that may be rewarded to the consumer 102 based on the aggregated time 324 at the location 306 and/or any activity including the location. In step 724, the transmitting unit 206 may transmit to the consumer 102 and/or the consumer device 104 their aggregated time 324 and any coupons that were identified in step 722.

In embodiments where the consumer 102 may be the member of a group 510, then, in steps 720 and 722, the processing unit 204 may aggregate the group time 516 for the group 510 based on the consumer's elapsed time, and may further identify any coupons the group 510 has earned based on the updated group time 516. Then, in step 724, the transmitting unit 206 may also transmit coupons to the group if any were identified in step 722.

In embodiments where a third party, such as the third party 120, requests activity information, then, in step 722, the processing unit 204 may identify if the aggregated time 324 for the consumer 102 (e.g., stored in the related consumer data entry 302) exceeds the time threshold 508 for the corresponding entity 502. If it does, then the transmitting unit 206 may transmit a notification to the third party indicating that the consumer 102 has exceeded the time threshold 508 for the corresponding activity.

### Computer System Architecture

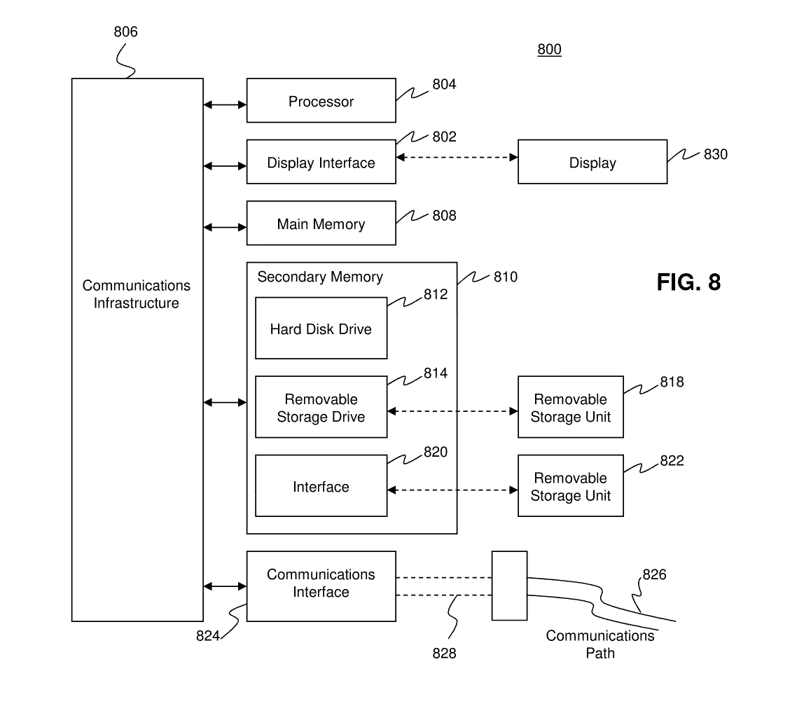

FIG. 8 illustrates a computer system 800 in which embodiments of the present disclosure, or portions thereof, may be implemented as computer-readable code. For example, the processing server 108 and the consumer device 104 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 7 and 9-11.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Processor device 804 may be a special purpose or a general purpose processor device. The processor device 804 may be connected to a communication infrastructure 806, such as a bus, message queue, network (e.g., the network 122), multi-core message-passing scheme, etc. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive, the removable storage unit 818 may be a floppy disk. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

Computer program medium and computer usable medium may refer to memories, such as the main memory 808 and secondary memory 810, which may be memory semiconductors (e.g. DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 7 and 9-11, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

### First Exemplary Method for Distributing Time- and Location-Based Offers

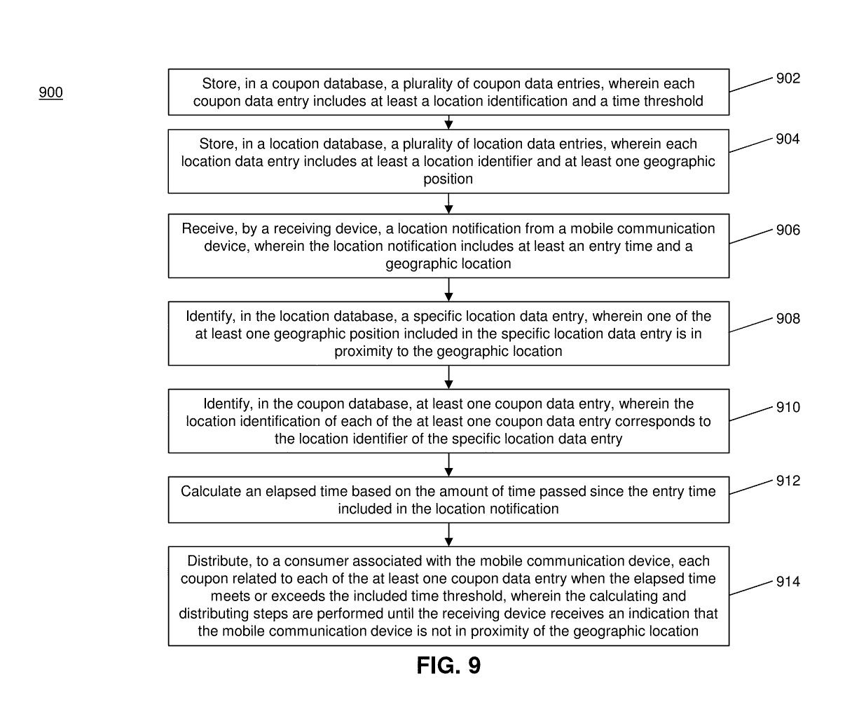

FIG. 9 illustrates a method 900 for distributing time- and location-based offers to a consumer (e.g., the consumer 102) and/or a consumer device (e.g., the consumer device 104).

In step 902, a plurality of coupon data entries (e.g., coupon data entries 316) may be stored in a coupon database (e.g., the coupon database 110), wherein each coupon data entry 316 includes data related to a coupon and includes at least a location identification (e.g., the location identification 320) and a time threshold (e.g., the time threshold 322). In one embodiment, each coupon data entry 316 may further include at least one of: a transaction modifier, a quantity, a start date, an expiration date, a merchant identifier, and a category. In step 904, a plurality of location data entries (e.g., location data entries 310) may be stored in a location database (e.g., the location database 112), wherein each location data entry 310 includes at least a location identifier (e.g., the location identifier 312) and at least one geographic position (e.g., the geographic position 314).

In step 906, a location notification may be received, by a receiving device (e.g., the receiving unit 202) from a mobile communication device (e.g., the consumer device 104), wherein the location notification includes at least an entry time and a geographic location. In one embodiment, the geographic location and the at least one geographic position 314 may be represented using longitude and latitude. In step 908, a specific location data entry be identified in the location database 112, wherein one of the at least one geographic positions 314 included in the specific location data entry is in proximity to the geographic location. In one embodiment, each location data entry 310 may further include a proximity distance, and identifying the specific location data entry may include identifying a specific location data entry wherein one of the at least one geographic positions 314 included in the specific location data entry is within the included proximity distance to the geographic location.

In step 910, at least one coupon data entry 316 may be identified in the coupon database 110, wherein the location identification 320 for each of the at least one coupon data entry corresponds to the location identifier 312 of the specific coupon data entry. In step 912, an elapsed time may be calculated based on the amount of time passed since the entry time included in the location notification.

In step 914, each coupon related to each of the at least one coupon data entry may be distributed to the consumer 102 associated with the consumer device 104 when the elapsed time meets or exceeds the included time threshold 322. Steps 912 and 914 of the method 900 may be performed until the receiving device receives an indication that the consumer device 104 is not in proximity of the geographic location. In one embodiment, each coupon related to each of the at least one coupon data entry may be distributed to the consumer device 104.

### Second Exemplary Method for Distributing Time- and Location-Based Offers

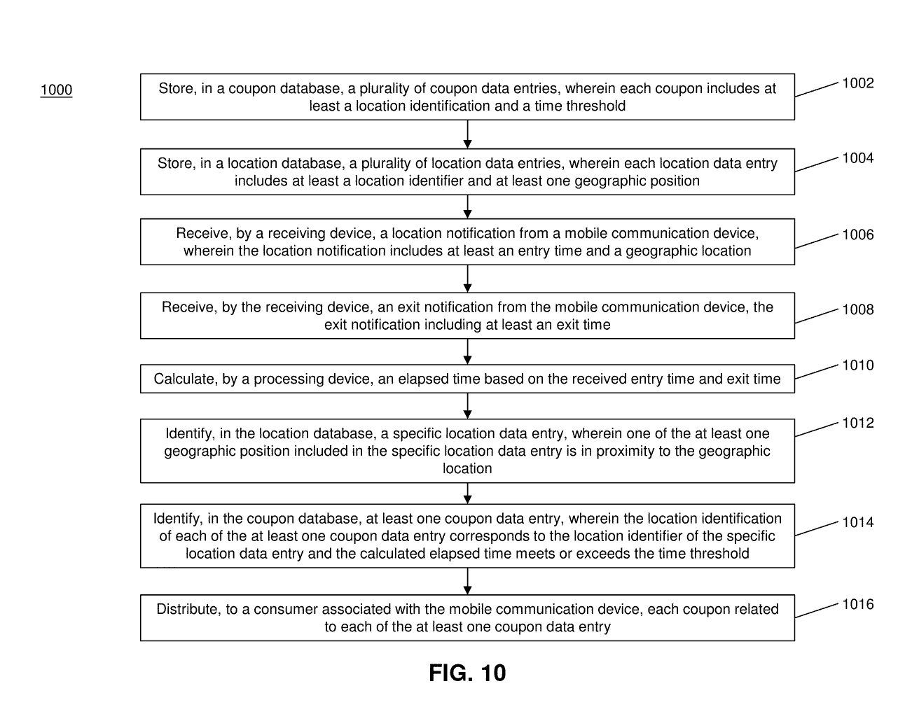

FIG. 10 illustrates a method 1000 for distributing time- and location-based offers to a consumer (e.g., the consumer 102) and/or a consumer device (e.g., the consumer device 104).

In step 1002, a plurality of coupon data entries (e.g., coupon data entries 316) may be stored in a coupon database (e.g., the coupon database 110), wherein each coupon data entry 316 includes data related to a coupon and includes at least a location identification (e.g., the location identification 320) and a time threshold (e.g., the time threshold 322). In one embodiment, each coupon data entry 316 may further include at least one of: a transaction modifier, a quantity, a start date, an expiration date, a merchant identifier, and a category. In step 1004, a plurality of location data entries (e.g., location data entries 310) may be stored in a location database (e.g., the location database 112), wherein each location data entry 310 includes data related to a location and includes at least a location identifier (e.g., the location identifier 312) and at least one geographic position (e.g., the geographic position 314).

In step 1006, a location notification may be received, by a receiving device (e.g., the receiving unit 202), from a mobile communication device (e.g., the consumer device 104), wherein the location notification includes at least an entry time and a geographic location. In one embodiment, the at least one geographic position 314 and the geographic location may be represented using latitude and longitude. In step 1008, an exit notification may be received by the receiving unit 202 from the consumer device 104, wherein the exit notification includes at least an exit time. In step 1010, an elapsed time may be calculated, by a processing device (e.g., the processing unit 204), based on the received entry time and exit time.

In step 1012, a specific location data entry may be identified in the location database 112, wherein one of the at least one geographic position 314 included in the specific location data entry is in proximity to the geographic location. In one embodiment, each location 310 of the plurality of locations may further include a proximity distance, and identifying the specific location data entry may include identifying a specific location data entry wherein one of the at least one geographic position 314 included in the specific location data entry is within the proximity distance to the geographic location.

In step 1014, at least one coupon data entry 316 in the coupon database 110 may be identified, wherein the location identification 320 of each of the at least one coupon data entry 316 corresponds to the location identifier of the specific location data entry and the calculated elapsed time meets or exceeds the time threshold 322. In step 1016, each coupon related to each of the at least one coupon may be distributed to a consumer (e.g., the consumer 102) associated with the consumer device 104. In one embodiment, each coupon may be distributed to the consumer device 104.

In one embodiment, the location notification may further include a consumer identification, and the method 1000 may further include storing, in a consumer database (e.g., the consumer database 118), a plurality of consumer data entries (e.g., the consumers 302), wherein each consumer data entry 302 includes data related to a consumer and includes a consumer identifier (e.g., the consumer identifier 304), a location identification (e.g., the geographic location 306), and an aggregated time (e.g., the aggregated time 324). The method 1000 may also include identifying, in the consumer database 118, a specific consumer data entry 302, wherein the included consumer identifier 304 corresponds to the consumer identification and the included location identification corresponds to the location identifier 312 of the specific location data entry. The method 1000 may also include updating the aggregated time 324 included in the specific consumer data entry 302 based on the received entry time and exit time. In a further embodiment, the elapsed time used in step 1014 may be based on the updated aggregated time 324.

In an even further embodiment, each consumer data entry 302 may include at least one group identification (e.g., group identification 326), and the method 1000 may further include identifying, in the consumer database 118, a plurality of grouped consumer data entries (e.g., the group 510) wherein each consumer data entry 302 in the plurality of grouped consumer data entries includes a group identification 326 corresponding to a group identifier (e.g., the group identifier 512) included in the specific consumer data entry. The method 1000 may also include calculating a group time (e.g., the group time 516) based on the aggregated time 324 included in each of the grouped consumer data entries, identifying in the coupon database 110 at least one group coupon data entry 316 where the location identification 320 of each of the at least one group coupon data entry 316 corresponds to the location identifier 312 of the specific location and the calculated group time 514 meets or exceeds the time threshold 322, and distributing, to each consumer associated with any of the plurality of grouped consumer data entries data entry, each coupon related to each of the identified at least one group coupon data entry 316. In yet a further embodiment, the aggregated time 324 and/or the group time 516 may be reset after a predetermined period of time.

### Exemplary Method for Distributing Time- and Location-Based Activity

FIG. 11 illustrates a method 1100 for distributing time- and location-based activity information.

In step 1102, a plurality of entity data entries (e.g., entity data entries 502) may be stored in an entity database (e.g., the entity database 114), wherein each entity data entry 502 includes data related to an entity includes at least a time threshold (e.g., the time threshold 508) and an activity identification (e.g., the activity identification 506). In step 1104, a plurality of activity data entries may be stored in an activity database (e.g., the activity database 116), wherein each activity data entry includes data related to an activity and includes an activity identifier and at least one geographic position.

In step 1106, a plurality of consumer data entries (e.g., consumers 302) may be stored in a consumer database (e.g., the consumer database 18), wherein each consumer data entry 302 includes at least a consumer identifier (e.g., the consumer identifier 304), an activity indicator (e.g., the activity 328), and an aggregated time (e.g., the aggregated time 324). In step 1108, an activity notification may be received by a receiving device (e.g., the receiving unit 202), wherein the activity notification includes at least a consumer identification, an elapsed time, and a geographic location. In one embodiment, the at least one geographic position and the geographic location may be represented using longitude and latitude.

In step 1110, a specific activity data entry may be identified in the activity database 116, wherein the geographic location corresponds to one of the at least one geographic positions included in the specific activity data entry. In one embodiment, each activity data entry in the activity database may further include a proximity distance, and identifying the specific activity data entry may include identifying a specific activity data entry where one of the at least one geographic position included in the specific activity data entry is within the included proximity distance to the geographic location. In step 1112, a specific consumer data entry 302 may be identified in the consumer database 118, wherein the consumer identification corresponds to the consumer identifier 304 included in the specific consumer data entry 302 and wherein the activity identifier of the specific activity data entry corresponds to the activity indicator 328 included in the specific consumer data entry 302.

In step 1114, the aggregated time 324 in the specific consumer data entry 302 may be updated based on the elapsed time included in the activity notification. In step 1116, a specific entity data entry 502 may be identified in the entity database 114, wherein the activity identifier of the specific activity data entry corresponds go the activity identification 506 included in the specific entity data entry 502 and the updated aggregated time 324 meets or exceeds the time threshold 508 included in the specific entity data entry 502. In step 1118, at least the consumer identifier 304 included in the specific consumer data entry 302 may be transmitted to the entity (e.g., the third party 120) related to the specific entity data entry 502.

Techniques consistent with the present disclosure provide, among other features, systems and methods for the distribution of time- and location-based offers and activities. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for distributing a time- and location-based offer to a consumer, comprising:
storing, in a coupon database, a plurality of coupon data entries, wherein each coupon data entry includes data related to a coupon and includes at least a location identification and a time threshold;
storing, in a location database, a plurality of location data entries, wherein each location data entry includes data related to a location and includes at least a location identifier and at least one geographic position;
receiving, by a receiving device, a location notification from a mobile communication device, wherein the location notification includes at least an entry time and a geographic location;
identifying, in the location database, a specific location data entry, wherein one of the at least one geographic position included in the specific location data entry is in proximity to the geographic location;
identifying, in the coupon database, at least one coupon data entry, wherein the location identification of each of the at least one coupon data entry corresponds to the location identifier of the specific location data entry;
calculating an elapsed time based on the amount of time passed since the entry time included in the location notification; and
distributing, to a consumer associated with the mobile communication device, each coupon related to each of the at least one coupon data entry when the elapsed time meets or exceeds the included time threshold,
wherein the calculating and distributing steps are performed until the receiving device receives an indication that the mobile communication device is not in proximity of the geographic location.

2. The method of claim 1, wherein each coupon data entry further includes at least one of: a transaction modifier, a quantity, a start date, an expiration date, a merchant identifier, and a category.

3. The method of claim 1, wherein the geographic location is represented using longitude and latitude.

4. The method of claim 1, wherein each location data entry of the plurality of location data entries further includes a proximity distance, and wherein identifying the specific location data entry includes identifying a specific location data entry wherein one of the at least one geographic position included in the specific location data entry is within the included proximity distance to the geographic location.

5. The method of claim 1, wherein distributing each coupon related to each of the at least one coupon data entry includes distributing each coupon to the mobile communication device.

6. A method for distributing a time- and location-based offer to a consumer, comprising:
storing, in a coupon database, a plurality of coupon data entries, wherein each coupon data entry includes data related to a coupon and includes at least a location identification and a time threshold;
storing, in a location database, a plurality of location data entries, wherein each location data entry includes data related to a location and includes at least a location identifier and at least one geographic position;
receiving, by a receiving device, a location notification from a mobile communication device, wherein the location notification includes at least an entry time and a geographic location;
receiving, by the receiving device, an exit notification from the mobile communication device, the exit notification including at least an exit time;
calculating, by a processing device, an elapsed time based on the received entry time and exit time;
identifying, in the location database, a specific location data entry, wherein one of the at least one geographic position included in the specific location data entry is in proximity to the geographic location;
identifying, in the coupon database, at least one coupon data entry, wherein the location identification of each of the at least one coupon data entry corresponds to the location identifier of the specific location and the calculated elapsed time meets or exceeds the time threshold; and
distributing, to a consumer associated with the mobile communication device, each coupon related to each of the at least one coupon data entry.

7. The method of claim 6, wherein the location notification further includes a consumer identification, and the method further comprises:
storing, in a consumer database, a plurality of consumer data entries, each consumer data entry including data related to a consumer and including a consumer identifier, a location identification, and an aggregated time;
identifying, in the consumer database, a specific consumer data entry, wherein the included consumer identifier corresponds to the consumer identification and the included location identification corresponds to the location identifier of the specific location data entry; and
updating the aggregated time included in the specific consumer data entry based on the received entry time and exit time,
wherein the elapsed time is based on the updated aggregated time.

8. The method of claim 7, wherein each consumer data entry includes at least one group identification, and the method further comprises:
identifying, in the consumer database, a plurality of grouped consumer data entries wherein each consumer data entry in the plurality of grouped consumer data entries includes a group identification corresponding to a group identifier included in the specific consumer data entry;
calculating an group time based on the aggregated time included in each of the grouped consumer data entries;
identifying, in the coupon database, at least one group coupon data entry, wherein the location identification of each of the at least one group coupon data entry corresponds to the location identifier of the specific location data entry and the calculated group time meets or exceeds the time threshold; and
distributing, to each consumer associated with any of the plurality of grouped consumer data entries, each coupon related to each of the identified at least one group coupon data entry.

9. The method of claim 7, wherein the aggregated time is reset after a predetermined period of time.

10. The method of claim 6, wherein each coupon data entry further includes at least one of: a transaction modifier, a quantity, a start date, an expiration date, a merchant identifier, and a category.

11. The method of claim 6, wherein the geographic location is represented using longitude and latitude.

12. The method of claim 6, wherein each location data entry of the plurality of location data entries further includes a proximity distance, and wherein identifying the specific location data entry includes identifying a specific location wherein one of the at least one geographic position included in the specific location data entry is within the included proximity distance to the geographic location.

13. The method of claim 6, wherein distributing each coupon related to each of the at least one coupon data entry includes distributing each coupon to the mobile communication device.

14. A method for distributing time- and location-based activity, comprising:
storing, in an entity database, a plurality of entity data entries, wherein each entity data entry includes data related to an entity and includes at least a time threshold and an activity identification;
storing, in an activity database, a plurality of activity data entries, wherein each activity data entry includes data related to an activity and includes an activity identifier and at least one geographic position;
storing, in a consumer database, a plurality of consumer data entries, wherein each consumer data entry includes data related to a consumer and includes at least a consumer identifier, an activity indicator, and an aggregated time;
receiving, by a receiving device, an activity notification, wherein the activity notification includes at least a consumer identification, an elapsed time, and a geographic location;
identifying, in the activity database, a specific activity data entry, wherein the geographic location corresponds to one of the at least one geographic positions included in the specific activity data entry;
identifying, in the consumer database, a specific consumer data entry, wherein the consumer identification corresponds to the consumer identifier included in the specific consumer data entry and wherein the activity identifier of the specific activity data entry corresponds to the activity indicator included in the specific consumer data entry;
updating the aggregated time in the specific consumer data entry based on the elapsed time included in the activity notification;
identifying, in the entity database, a specific entity data entry, wherein the activity identifier of the specific activity data entry corresponds to the activity identification included in the specific entity data entry and the updated aggregated time meets or exceeds the time threshold included in the specific entity data entry; and
transmitting, to the entity related to the specific entity data entry, at least the consumer identifier included in the specific consumer data entry.

15. The method of claim 14, wherein the geographic location is represented using longitude and latitude.

16. The method of claim 14, wherein each activity data entry of the plurality of activity data entries further includes a proximity distance, and wherein identifying the specific activity data entry includes identifying a specific activity data entry wherein one of the at least one geographic position included in the specific activity data entry is within the included proximity distance to the geographic location.

17. A system for distributing a time- and location-based offer to a consumer, comprising:
a coupon database configured to store a plurality of coupon data entries, wherein each coupon data entry includes data related to a coupon and includes at least a location identification and a time threshold;
a location database configured to store a plurality of location data entries, wherein each location data entry includes data related to a location and includes at least a location identifier and at least one geographic position;
a receiving device configured to receive a location notification from a mobile communication device, wherein the location notification includes at least an entry time and a geographic location;
a processing device configured to
identify, in the location database, a specific location data entry, wherein one of the at least one geographic position included in the specific location data entry is in proximity to the geographic location,
identify, in the coupon database, at least one coupon data entry, wherein the location identification of each of the at least one coupon data entry corresponds to the location identifier of the specific location data entry, and
calculate an elapsed time based on the amount of time passed since the entry time included in the location notification; and
a transmitting device configured to transmit, to a consumer associated with the mobile communication device, each coupon related to each of the at least one coupon data entry when the elapsed time meets or exceeds the included time threshold,
wherein the processing device is configured to perform the calculating and distributing until the receiving device receives an indication that the mobile communication device is not in proximity of the geographic location.

18. The system of claim 17, wherein each coupon data entry further includes at least one of: a transaction modifier, a quantity, a start date, an expiration date, a merchant identifier, and a category.

19. The system of claim 17, wherein the geographic location is represented using longitude and latitude.

20. The system of claim 17, wherein each location data entry of the plurality of location data entries further includes a proximity distance, and wherein identifying the specific location data entry includes identifying a specific location data entry wherein one of the at least one geographic position included in the specific location data entry is within the included proximity distance to the geographic location.

21. The system of claim 17, wherein transmitting each coupon related to each of the at least one coupon data entry includes transmitting each coupon to the mobile communication device.

22. A system for distributing a time- and location-based offer to a consumer, comprising:
a coupon database configured to store a plurality of coupon data entries, wherein each coupon data entry includes data related to a coupon and includes at least a location identification and a time threshold;
a location database configured to store a plurality of location data entries, wherein each location data entry includes data related to a location and includes at least a location identifier and at least one geographic position;
a receiving device configured to
receive a location notification from a mobile communication device, wherein the location notification includes at least an entry time and a geographic location, and
receive an exit notification from the mobile communication device, the exit notification including at least an exit time;
a processing device configured to
calculate an elapsed time based on the received entry time and exit time,
identify, in the location database, a specific location data entry, wherein one of the at least one geographic position included in the specific location data entry is in proximity to the geographic location, and
identify, in the coupon database, at least one coupon data entry, wherein the location identification of each of the at least one coupon data entry corresponds to the location identifier of the specific location data entry and the calculated elapsed time meets or exceeds the time threshold; and
a transmitting device configured to transmit, to a consumer associated with the mobile communication device, each coupon related to each of the at least one coupon data entry.

23. The system of claim 22, further comprising:
a consumer database configured to store a plurality of consumer data entries, each consumer data entry including data related to a consumer and including a consumer identifier, a location identification, and an aggregated time, wherein
the location notification further includes a consumer identification,
the processing device is further configured to update the aggregated time included in the specific consumer data entry based on the received entry time and exit time, and
the elapsed time is based on the updated aggregated time.

24. The system of claim 23, wherein
each consumer data entry includes at least one group identifier;
the processing device is further configured to
identify, in the consumer database, a plurality of grouped consumer data entries wherein each consumer data entry in the plurality of grouped consumer data entries includes a group identifier corresponding to a group identifier included in the specific consumer data entry,
calculate an group time based on the aggregated time included in each of the grouped consumer data entries, and
identify, in the coupon database, at least one group coupon data entry, wherein the location identification of each of the at least one group coupon data entry corresponds to the location identifier of the specific location and the calculated group time meets or exceeds the time threshold; and
the transmitting device is further configured to transmit, to each consumer related to each consumer data entry associated with any of the plurality of grouped consumer data entries, each coupon related to each of the identified at least one group coupon data entry.

25. The system of claim 23, wherein the aggregated time is reset after a predetermined period of time.

26. The system of claim 22, wherein each coupon data entry further includes at least one of: a transaction modifier, a quantity, a start date, an expiration date, a merchant identifier, and a category.

27. The system of claim 22, wherein the geographic location is represented using longitude and latitude.

28. The system of claim 22, wherein each location data entry of the plurality of location data entries further includes a proximity distance, and wherein identifying the specific location data entry includes identifying a specific location data entry wherein one of the at least one geographic position included in the specific location data entry is within the included proximity distance to the geographic location.

29. The system of claim 22, wherein distributing each coupon related to each of the at least one coupon data entry includes distributing each coupon to the mobile communication device.

30. A system for distributing time- and location-based activity, comprising:
an entity database configured to store a plurality of entity data entries, wherein each entity data entry includes data related to an entity and includes at least a time threshold and an activity identification;
an activity database configured to store a plurality of activity data entries, wherein each activity data entry includes data related to an activity and includes an activity identifier and at least one geographic position;
a consumer database configured to store a plurality of consumer data entries, wherein each consumer data entry includes data related to a consumer and includes at least a consumer identifier, an activity indicator, and an aggregated time;
a receiving device configured to receive an activity notification, wherein the activity notification includes at least a consumer identification, an elapsed time, and a geographic location;
a processing device configured to
identify, in the activity database, a specific activity data entry, wherein the geographic location corresponds to one of the at least one geographic positions included in the specific activity data entry,
identify, in the consumer database, a specific consumer data entry, wherein the consumer identification corresponds to the consumer identifier included in the specific consumer data entry and wherein the activity identifier of the specific activity data entry corresponds to the activity indicator included in the specific consumer data entry,
update the aggregated time in the specific consumer data entry based on the elapsed time included in the activity notification, and
identify, in the entity database, a specific entity data entry, wherein the activity identifier of the specific activity data entry corresponds to the activity identification included in the specific entity data entry and the updated aggregated time meets or exceeds the time threshold included in the specific entity data entry; and
a transmitting device configured to transmit, to the entity related to the specific entity data entry, at least the consumer identifier included in the specific consumer data entry.

31. The system of claim 30, wherein the geographic location is represented using longitude and latitude.

32. The system of claim 30, wherein each activity data entry of the plurality of activity data entries further includes a proximity distance, and wherein identifying the specific activity data entry includes identifying a specific activity data entry wherein one of the at least one geographic position included in the specific activity data entry is within the included proximity distance to the geographic location.
